(19) United States
(12) Patent Application Publication
(10) Pub. No.: US 2009/0135279 A1
(43) Pub. Date: May 28, 2009

(54) REDUCING IMAGING ARTIFACTS CAUSED BY DEFECTIVE IMAGING ELEMENT

(75) Inventor: Meng Yao, West Linn, OR (US)

Correspondence Address: MARGER JOHNSON & MCCOLLOM, P.C. - Xerox, 210 SW MORRISON STREET, SUITE 400, PORTLAND, OR, 97204, US

(73) Assignee: XEROX CORPORATION, Norwalk, CT (US)

(21) Appl. No.: 11/944,810

(22) Filed: Nov. 26, 2007

(51) Int. Cl. H04N 9/64

(52) U.S. Cl. 348/246; 348/E09.037

(57) ABSTRACT

A method of compensating for a defective imaging element includes measuring an actual value generated by a defective element, comparing an actual value to an image value resulting in a comparison value, and adjusting neighboring image values for at least an imaging element immediately adjacent to the defective imaging element depending upon the comparison value. An imaging system has an array of imaging elements, having at least one defective imaging element, a processor to operate the array of imaging elements, the processor to determine an actual value produced by a defective imaging element, compare the actual value to an image value for the defective imaging element resulting in a comparison value, and adjust operation of at least an imaging element immediately adjacent the defective imaging element, based upon the comparison value.

### BACKGROUND

Many imaging devices rely upon individual imaging elements to capture or create images. Printers may employ ink jets consisting of arrays of jets each to deposit drops of ink on a printing substrate. Displays may consist of arrays of individual elements, such as liquid crystal cells, where the color and state of the elements creates the image seen by viewers. Scanners and digital cameras may use charge-coupled devices (CCDs) to convert visual data into electrical signals.

In any of these devices, a failure of an element affects the resulting image. A printer with a failed jet may produce images with bands. A display with a failed element may leave a permanent image on the display. Failed CCDs will cause streaks in the captured images. Generally, the elements reside inside the device relying upon them to function correctly and repair of the defective element is difficult and expensive.

For example, to disassemble the device, replace the array of elements, perform any necessary testing and calibration, and then reassemble the device takes considerable time and effort. Further, depending upon the nature of the system and alignment concerns, the repaired device may not function as well as desired.

### BRIEF DESCRIPTION OF THE DRAWINGS

FIG. 1 shows an example of an artifact in an image caused by a defective element.

FIG. 2 shows an example of an artifact in a displayed image caused by a failed element.

FIG. 3 shows an example of a printer having an array of jets.

FIG. 4 shows a flowchart of one embodiment of a method of adjusting operation of an array of elements to compensate for a defective element.

FIG. 5 shows an example of a printed image with compensation for a defective element.

### DETAILED DESCRIPTION OF THE EMBODIMENTS

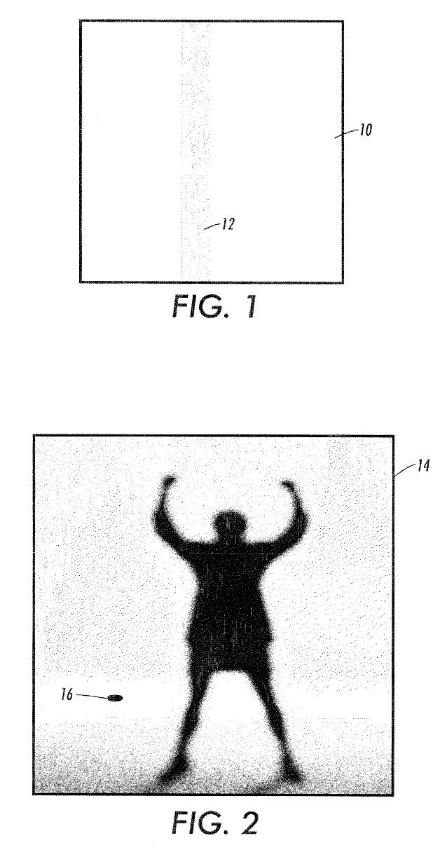

FIG. 1 shows an image artifact due to malfunctioning imaging elements. An imaging element, as used here, consists of an individual element used to form images. The element may form the image by ‘glowing’ or radiating light, as in a phosphor based screen such as a cathode ray tube (CRT) display; modulating light, as in a liquid crystal element or microelectromechanical (MEMS) element; dispensing ink or electric charge in a printing system; or by receiving light to be converted into an image value, as in a charge coupled devices (CCD) or other scanning elements, as examples.

When an imaging element malfunctions in a display, it causes artifacts such as that shown in image 10 at region 12. This artifact may result from ‘burn in’ on a phosphor-based or other type of coating used display screen, also referred to as permanent image retention. Due to the burn-in effect, for a color display, for example, the region or ‘stripe’ 12 may show up as red, even though the image values intended to be displayed should have shown up as white. Image values consist of the values of what is intended to be displayed, the data values that were sent to the display controller for display. Actual values are those that are actually depicted on the screen, paper or in the received image data in the case of scanners.

For example, assume that the strip in FIG. 1 is red. The image values consisted of Red=255, Green=255, and Blue=255, or full color for an 8-bit system (28=256 levels, or 0 to 255 image values per color) that should result in the region 12 being white. However, due to burn-in effects of the red phosphors, or a malfunctioning imaging element that depicts the shades of red, the actual image values are R=255, G=250 and B=250. Because of the dominant color Red, the strip appears red.

In an alternative example, where the defect is more localized, the failing imaging element may cause a dark spot to appear when the spot should display white. FIG. 2 shows an example of an image artifact occurring in a more localized fashion. The image 14 shows a dark region 16 where it should be white.

As an example in a printer, assume that the stripe 12 represents malfunctioning jets. In a monochrome printing system, the stripe would appear to be gray or white against the darker surrounding area. For color printers, the stripe would have a different color than the surrounding colors.

In this instance, the image values would be 255, with the actual value being only 250. This would probably occur because of a failing jet or region of jets that do not dispense enough ink to cause the printed density to match the image density desired.

Many image correcting approaches tend to try to make the malfunctioning imaging element look more like the adjacent imaging elements that function correctly. However, one can instead mitigate the effects of the defective imaging element or elements by making the surrounding area look more like the defective elements. This approach takes advantage of the influence of a surrounding region on color perception by the human visual system. By manipulating the surrounding region of a defective imaging element, this approach causes the human visual system to ‘blur’ the objectionable artifact and results in a reduction of the artifact's impact on the image.

It must be noted that this approach differs greatly from merely applying a blurring, or low-pass, filter to the image. A low-pass filter has the effect of blurring the entire image and removing or reducing the details of the image. This approach still allows for good detail, but mitigates the effect of defective elements. One view of this approach could be as equivalent to blurring the actual image, and not the original image. By blurring the actual image at locations corresponding to the defective elements, perceptually it represents the intended image much better than the original image data because the artifact caused by defective elements can severely distort the intended image.

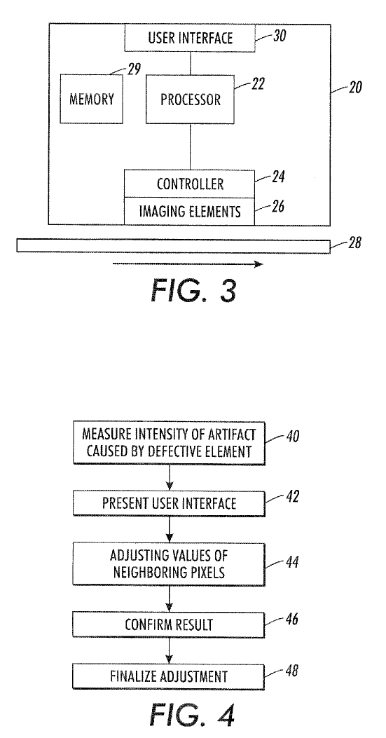

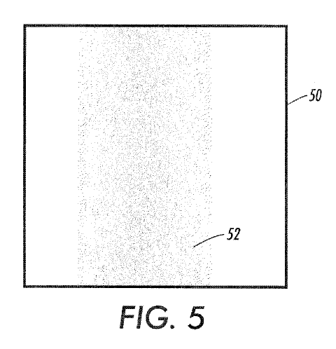

FIG. 3 shows an embodiment imaging system 20 capable of reducing the effect of defective imaging elements. The imaging system has a user interface 30 of some sort, whether it be an on-screen display such as in a video or image display, or a control panel as in a printer or scanner. The system also has a processor 22, typically with an associated memory 29 for storing data and/or storing software code to be executed by the processor 22. The processor may operate the imaging elements 26 directly, but as systems become more and more complex, dedicated controllers 24, such as microcontrollers and digital signal processors generally drive the various sub-functions of a system including the array of imaging elements 26.

In the case of a printer, the imaging elements 26 would form the image on a print substrate 28 that moves from left to right across the page in this example. For display applications, the element 28 may be a display screen with intermediate optics, or may be an optional component. For a scanner, the component 28 would be the substrate containing image to be scanned.

Generally, the imaging system 20 would include the necessary routines and control operations to have the corrections made in the field. Alternatively, a service technician would have the necessary instructions to cause the processor to alter its operation to adjust for a defective imaging element. In addition, the alteration may occur prior to the system shipping, depending upon the severity of the defect and the complexity of the overall system.

FIG. 4 shows an embodiment of a method of adjusting, altering, or otherwise compensating for a defective imaging element. Upon detection of the presence of a defective imaging element, such as by noticing image artifacts on a display, seeing stripes in a printed image, or streaks or stripes in a scanned image, the user or technician would begin the correction process. At 40, the system or technician would measure the intensity of the artifact. The intensity, as used here, means any measure of the artifact that can be used to ‘spread’ out the effects of the defective element, such as the ‘level’ or value in an RGB, CMY, CMYK (where K is black), or black and white imaging system.

In the case of the system making the determination, the system may perform a measurement on the resulting artifact. In this embodiment, the system may print a test page, feed it back into the system to the scanner, and then scan the test page. The system could then analyze the test page to determine which, if any, elements are malfunctioning, and measure the strength of the malfunctioning elements. Alternatively, a measuring device could be built into the system to fully automate the process. For example, a densitometer can be installed inside a printer, which can measure the density of test patches that are formed on a charged photoconductive belt or drum. This allows the system to detect and measure Malfunctioning elements and make appropriate imaging adjustments without user involvement.

In the case of a technician or user measure the intensity of the artifact, the actual value may be input through the user interface. The user interface would then allow the user/technician to manage the process at 42, if an interactive model were used. For an automated process the user interface may not exist, being optional. Generally, the automated process seems more likely.

At 44, the values of neighboring pixels, or picture elements, would be altered to compensate for the defective imaging elements. As used here, the pixels are the resulting image elements that are seen by a viewer. The image values for the imaging elements in the neighborhood of the defective element are adjusted or scaled.

The term neighborhood, as used here, could mean only the pixel values for the immediately adjacent imaging elements, or could be a region including a particular number of elements ‘away’ from the defective elements. This may become clearer using the examples given above.

For the display image that suffers from permanent image retention, the actual values were R=255, G=250 and B=250, for a situation where all image values were to be 255. In this instance, the immediately adjacent imaging element would be controlled to create a pixel having Blue and Green values of 251/255 on either side of the imaging element. Depending upon the application, the immediately adjacent pixels may include all of those in the ‘square’ around the particular defective image element, those immediately on either side, immediately above and below the defective image element, and those at the corners.

The next imaging element, one imaging element away from the defective imaging element, in whichever direction, would then have Blue and Green values of 252/255. Each successively distant neighboring element would then have a value of the previous element plus a step value, in this example 1. This is shown in the table below.

| Defective element N | Next element | | | | |
|---|---|---|---|---|---|
| value | N + 1 | N + 2 | N + 3 | N + 4 | N + 5 |
| 250 | 251 | 252 | 253 | 254 | 255 |

It is possible to ‘step out’ as many neighboring elements as needed to make the correction. Similarly, it is possible to have different step values, such as 2 or 3 values per step. However, having a higher step value may result in a blocking effect in the resulting image.

It should be noted that the various examples given above assist in understanding the issues with defective elements and constant image values. Embodiments disclosed here may also be applied to dynamic or changing image values. First, the defective element has to be measured. There are two approaches to measure it. The simplest approach is to measure the defective element at maximum intensity (255), assuming the actual value of a normal imaging element at maximum intensity is 255. Let Vd be the actual value of the measured defective element. The difference between a normal element and a defective element (255−Vd) is spread out to the neighboring elements of the defective elements. If one were to spread the difference up to N pixels away, each step is S=(255−Vd)/N. The immediate next pixel of the defective pixel would be scaled by (Vd+S)/255, and the pixel after that would be scaled by (Vd+2*S)/255. The Nth pixel would be scaled by (Vd+N*S)/255, which is equivalent to 1, which means the Nth pixel is not modified.

One needs to apply scaling to the image values of the pixels around the defective element because the pixel value at the defective element and the pixel values of the neighboring elements could be any value between 0 and 255. For example, if the image value at the defective pixel is 50, and the immediate pixel has a value of 200, 200 should be changed to 200*(Vd+S)/255.

The above approach measures the defective element at maximum intensity (255). A second and possibly more accurate approach is to measure it at different intensities, not just 255. For example, the defective element can be measured at 10% steps of 255, such as 26, 51, 77 . . . 255. At each level, Vd is obtained, for example, Vd1, Vd2 . . . Vd10. One could interpolate using these values and obtain a lookup table for the measured defective element at any value between 0 and 255. Basically, the result is an array of Vd, with 256 elements (Vd[256]), with the index ranging from 0 to 255. Vd[256] provides the measured value of the defective element at different intensity levels, although only 10 values are actually measured in this example, the rest obtained through interpolation. When applying adjustment to an image, this approach is similar to the simple approach above, except that the scaling factor is (Vd[x]+S)/255, instead of (Vd+S)/255, where x is the image value of the defective element.

A similar procedure would apply to a printer element that begins to malfunction. The other colors such as blue and green received the adjustment in the above example other than the dominant color such as red because of the burn-in effect. In the example of a printer, the operation of the properly functioning elements would be adjusted to compensate for the malfunctioning elements in all colors.

In the previous printer example, the actual value was 250, where it was supposed to be 255. If the malfunctioning element were a magenta jet, the neighboring image elements would have magenta values of 251, etc., until they reached the image value. The number of elements needed to reach the image value depends upon the size of the step value used.

In whatever manner, the neighboring pixels are adjusted to appear to be more like the defective elements at 44 in FIG. 4. The automated embodiment may then print and scan another test page to confirm the previous analysis performed at 42. In the interactive embodiment, the user may then have the option of confirming the result in 46. If the user finds the result objectionable the user would have the option to repeat the process to adjust the values until satisfied. Similarly, for the automated embodiment, various thresholds may exist in the analysis software that allows the system to determine if the adjustment is sufficient or not. In addition, the automated system may also have a threshold for determining if any adjustment should be made at all, or if the defective element is too weak or there are too many defective elements for the system to continue to function.

At 48, the user finalizes the adjustments. In either case, the user may be a user operating on the user's own equipment or a technician that has been called into the field. In addition to the finalization of the adjustment, the finalization may also include failing the device. Failing the imaging device with the imaging elements may result in a failure of the entire system, or just replacement of the failing device.

In this manner, an array of imaging elements having at least one defective element can have its operations altered to mitigate the effect of the defective element. This allows a system that may otherwise be unusable to be used.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A method of compensating for a defective imaging element, comprising:
measuring an actual value generated by a defective element;
comparing an actual value to an image value resulting in a comparison; and
adjusting neighboring image values for at least an imaging element immediately adjacent to the defective imaging element depending upon the comparison.

2. The method of claim 1, further comprising scaling the image values for the immediately adjacent imaging elements using a step value in conjunction with the actual value.

3. The method of claim 2, further comprising repeating the adjusting for further neighbor imaging elements using multiples of the step value.

4. The method of claim 3, wherein the repeating continues until the actual value reaches the image value.

5. The method of claim 1, wherein the adjusting occurs in at least one color.

6. The method of claim 1, wherein measuring an actual value further comprises automatically measuring an actual value using a test page and scanner.

7. The method of claim 1, wherein the imaging element further comprises one of a burned-in pixel on a display, a malfunctioning jet on a printer, or a malfunctioning element of a scanner.

8. An imaging system, comprising:
an array of imaging elements, having at least one defective imaging element;
a processor to operate the array of imaging elements, the processor to:
determine an actual value produced by a defective imaging element;
compare the actual value to an image value for the defective imaging element resulting in a comparison value; and
adjust operation of at least an imaging element immediately adjacent the defective imaging element, based upon the comparison value.

9. The system of claim 8, further comprising a memory.

10. The system of claim 8, wherein the array of imaging elements further comprises one of an array of display elements, an array of ink dispensing elements or an array of scanning elements.

11. The system of claim 8, the processor further to automatically measure the actual value.

12. The system of claim 8, further comprising a user interface.

13. The system of claim 12, the processor further to receive the actual value from the user interface.

14. The system of claim 12, wherein the process to adjust operation further comprising the processor to set an image value for the immediately adjacent element to be the actual value plus a step value.

15. A computer-readable media to store instructions such that when the instructions are executed, the instructions cause a computer to:
determine an actual value generated by a defective element;
compare an actual value to an image value resulting in a comparison value; and
adjust neighboring image values for at least an imaging element immediately adjacent to the defective imaging element depending upon the comparison value.

16. The computer-readable media of claim 15 to store instructions to adjust the computer to scale the image values for the immediately adjacent imaging elements using a step value in conjunction with the actual value.

17. The computer-readable media of claim 15 to store further instructions to cause the computer to repeat the adjusting for further neighbor imaging elements using multiples of the step value.

18. The computer-readable media of claim 17 to store further instructions to cause the computer to repeat until the actual value reaches the image value.

19. The computer-readable media of claim 15 to store further instructions to cause the computer to adjust in at least one color.

20. The computer-readable media of claim 15 to store further instructions to cause the computer to determine the actual value by one of either measuring or receiving the value through a user interface.
